(19) United States
(12) Patent Application Publication
(10) Pub. No.: US 2012/0085793 A1
(43) Pub. Date: Apr. 12, 2012

(54) COLLAPSIBLE SPOUT FOR A CONTAINER AND METHOD OF MANUFACTURE THEREOF

(75) Inventors: John R. SELINA, Brighton, MI (US); Randall J. CORBETT, Macomb, MI (US)

(73) Assignee: LETICA CORPORATION, Rochester, MI (US)

(21) Appl. No.: 13/048,986

(22) Filed: Mar. 16, 2011

Related U.S. Application Data
(63) Continuation-in-part of application No. 12/898,768, filed on Oct. 6, 2010.

(51) Int. Cl. B65D 25/44; B29C 70/84; B29C 67/00

(52) U.S. Cl. 222/529; 264/328.1; 264/259; 222/530

(57) ABSTRACT

The combination of molded plastic closure for an open top container and an extensible plastic spout adapted to be joined to the deck of the closure in either of two ways. In one way, the spout is molded with a U-shaped peripheral channel which receives a downwardly extending flange surrounding an aperture in the deck. In another way, the spout is pre-molded and then used as an insert when molding the closure.

### CROSS-REFERENCE TO RELATED APPLICATION

This application is a continuation-in-part of the co-pending U.S. patent application Ser. No. 12/898,768 filed Oct. 6, 2010 and assigned to Letica Corporation of Rochester, Mich. The entire content of the aforesaid parent application is incorporated herein by reference and a claim of priority is made thereto.

### FIELD OF THE INVENTION

This invention relates to collapsible spouts for closures used in combination with open top industrial containers.

### BACKGROUND OF THE INVENTION

It is known to install collapsible, but manually extensible, spouts in the closure decks of industrial containers for the purpose of facilitating the act of pouring out the contents of the container. One common spout uses a “roll sock” configuration wherein the soft plastic body of the spout is gradually turned inside out as the spout is extended. Roll sock spouts typically have three pieces and are of limited height.

### SUMMARY OF THE INVENTION

The present invention provides an improved spout for use in combination with closures of the type used for industrial shipping containers. In general, the spout of the present invention comprises a plastic body having a plurality of molded-in concentric pleats generally characterized by thinner cross-sectional areas at the annular hinge points. At the outlet end of the spout; i.e., the end which, in the extended condition, is farthest from the closure, features such as threads or annular ridges are molded into the spout collar to receive a cap which, when the spout is in the collapsed or folded condition, is normally substantially flush with the top surface of the closure deck.

In one embodiment, the other end of the spout; i.e., the larger diameter or “inlet” end, is characterized by a U-shaped channel which is designed to accept in complemental locking engagement therein, a downwardly extending annular flange which is an integral part of the closure deck and defines a circular opening therein. Thus, the spout can easily be snapped into engagement with the closure deck from the underside of the deck surface.

In another embodiment, the larger end of the spout body is insert-molded into the closure itself so as to be essentially an integral part thereof.

In the preferred embodiment described herein, a pull-ring is formed integrally with the cap and around the periphery thereof so that a person may grasp the pull-ring with two or more fingers, lift it up and away from its resting plane and exert an upward pressure on the spout through the cap so as to extend the spout into a stable partially or fully extended condition.

Also in the preferred embodiment hereinafter described in detail, a seal with a pull-ring is formed integrally inside of the spout collar so as to protect the contents of the container until such time as one desires to deploy the spout and gain access to such contents.

According to another aspect of the invention, the pleated body of the spout is molded in the collapsed condition with all of the pleats of the body as well as the outlet collar concentrically within one another in essentially the same plane.

### BRIEF SUMMARY OF THE DRAWINGS

The description herein makes reference to the accompanying drawings wherein like reference numerals refer to like parts throughout the several views and wherein:

FIG. 1 is a perspective view of a container comprising a lock-on closure equipped with a collapsible spout in accordance with a first embodiment of the invention;

FIG. 2 is a perspective view partly in section showing the construction of the spout and the closure deck in which the spout is mounted;

FIG. 3 shows the spout of FIG. 1 in an extended condition;

FIG. 4 is a side view of the spout showing how it can be asymmetrically extended; and

FIG. 4 is a side view of the spout showing how it can be asymmetrically extended;

FIG. 5 is another view showing an asymmetric extension of the spout;

FIG. 6 is a perspective view of a closure showing a second embodiment of the invention;

FIG. 7 is a perspective view of the spout of FIG. 6 in an extended condition; and

FIG. 8 is a sectional view of the embodiment of FIG. 6 undergoing an insert-molding process in a mold.

### DETAILED DESCRIPTION OF THE ILLUSTRATIVE EMBODIMENTS

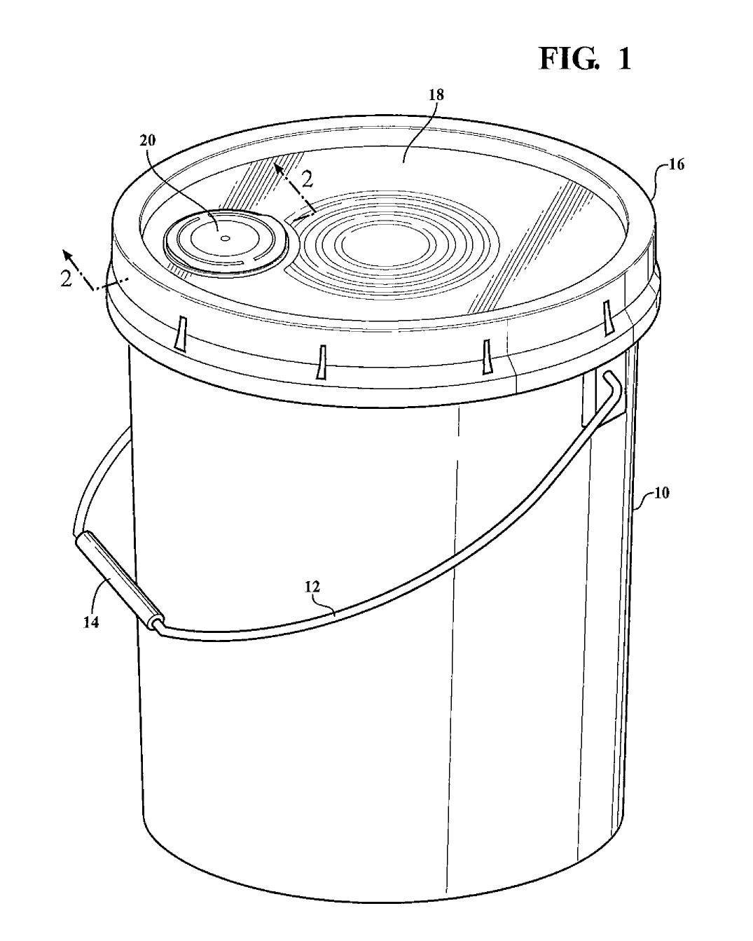

Referring to FIGS. 1 through 3, a five-gallon open-top molded container 10 is shown to be equipped with a bail 12 having a handle 14. The open top (not shown) of the container 10 is sealingly closed by a molded plastic closure 16 of well known design. Both the container 10 and the closure 16 are often and advantageously injection molded of high-density polyethylene; however, many other materials of construction may be used. The size of the container is given by way of example only.

The closure 16 is characterized by a generally flat central deck 18 having formed therein a circular opening which receives therein a two-piece spout assembly 20. The opening in the deck has a downwardly (or inwardly, relative to the interior of the container 10) extending flange 22 with an annular detent head for purposes to be described.

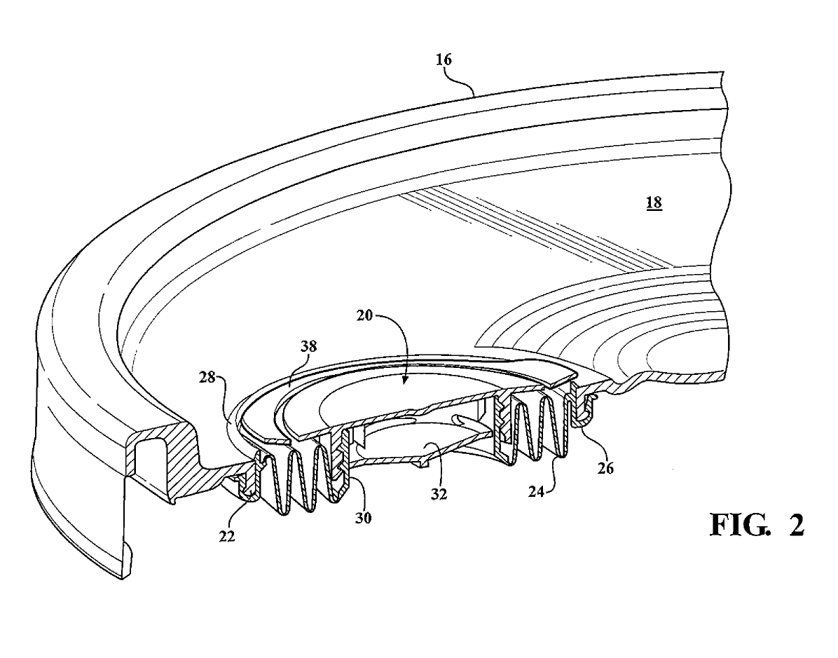

The spout assembly 20 comprises a molded plastic, concentrically-pleated spout body 24 which is molded with the pleated portions thereof concentric and in the collapsed condition shown in FIG. 2. The body of the spout has a large diameter inlet end 26 with a U-shaped peripheral channel adapted to lockingly receive the inwardly extending flange 22 of the closure deck 18 such that the spout is installed from the interior or underside of the closure deck; i.e., the spout 24 is inserted from the underside or bottom of the deck 18 and pushed upwardly into locking engagement with the flange 22. A peripheral flange 28 on the top of the U-shaped channel 26 seats against the top of the deck 18 just around the outside of the circular opening to provide a seal.

The smaller diameter or outlet end of the spout body is defined by a generally cylindrical collar 30 having external spiral threads formed thereon to receive a cap 36 which forms the second component of the spout assembly. The cap 36 comprises a cylindrical body portion 37 with internal threads to mate with the external threads of the collar 30. The cap 36 is equipped with an integral pull-ring 38 around the outer periphery thereof to exhibit the largest possible diameter. The pull-ring 38 is partially separated from the cap body by a circular gap or slot so that the pull-ring may be lifted and grasped in the hand when one wishes to extend the spout. In short, the spout is extended by grasping the pull-ring 38 with the cap 36 attached to the collar 30 and pulling upwardly until the pleats begin to unfold into any of various stable configurations.

A secondary seal 32 is formed integrally within the collar 30 and has its own pull-ring 34 in conventional fashion for selective removal when one wishes to deploy the spout and gain access to the contents of the container.

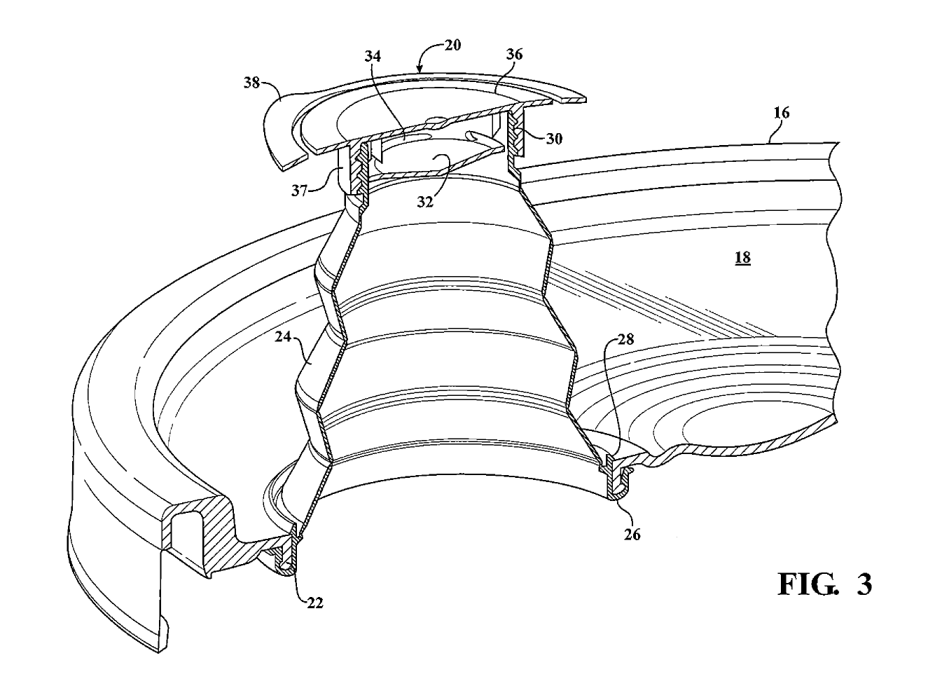

In a practical embodiment, the circular opening in the deck 18 is on the order of three inches in diameter and the remaining components of the assembly as shown in the Figures are scaled according to that dimension. It is apparent from FIGS. 2 and 3 that the pleated spout exhibits a large extension height thus making the act of pouring from the container 10 easier and less likely to produce spills.

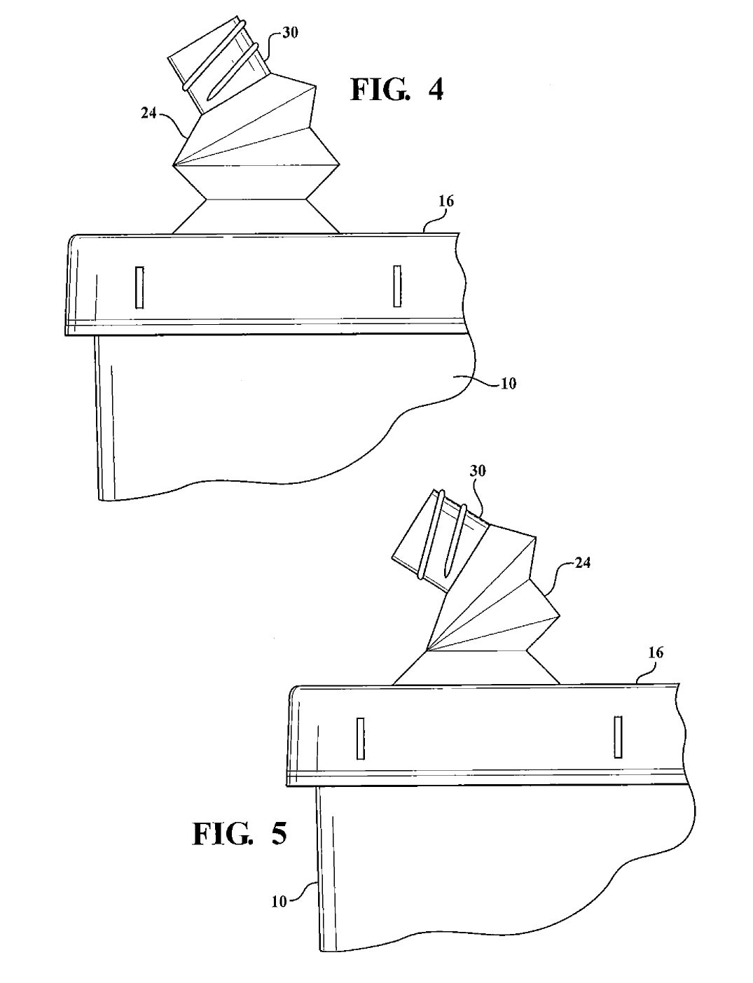

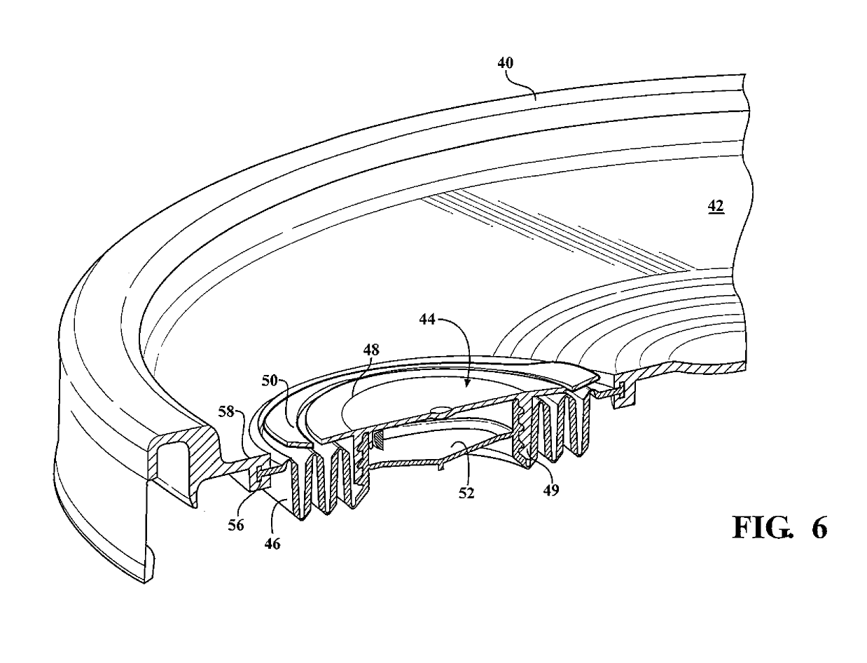

As shown in FIGS. 4 and 5, the spout 24 can be extended symmetrically and asymmetrically; i.e., the latter being characterized by a greater degree of pleat extension on one side of the spout than on the other thus to place the spout 24 in a “cocked” condition. The material of the body 24 is thinner at the pleats to provide an “over-center” release as each pleat is unfolded. Moreover, the fact that the spout body 24 is molded in the collapsed condition provides a “memory” function which assists in returning the spout from the extended position to the collapsed condition within the opening in the closure deck 18.

The method of the present invention comprises, overall, the steps of providing a mold which affords the appropriate design for the spout, and molding the spout in the collapsed condition with the pleats and the collar 30 concentric and essentially monoplanar. The mold is such as to create the thin cross-sections at the pleat hinge points as can be seen in FIGS. 2 and 3.

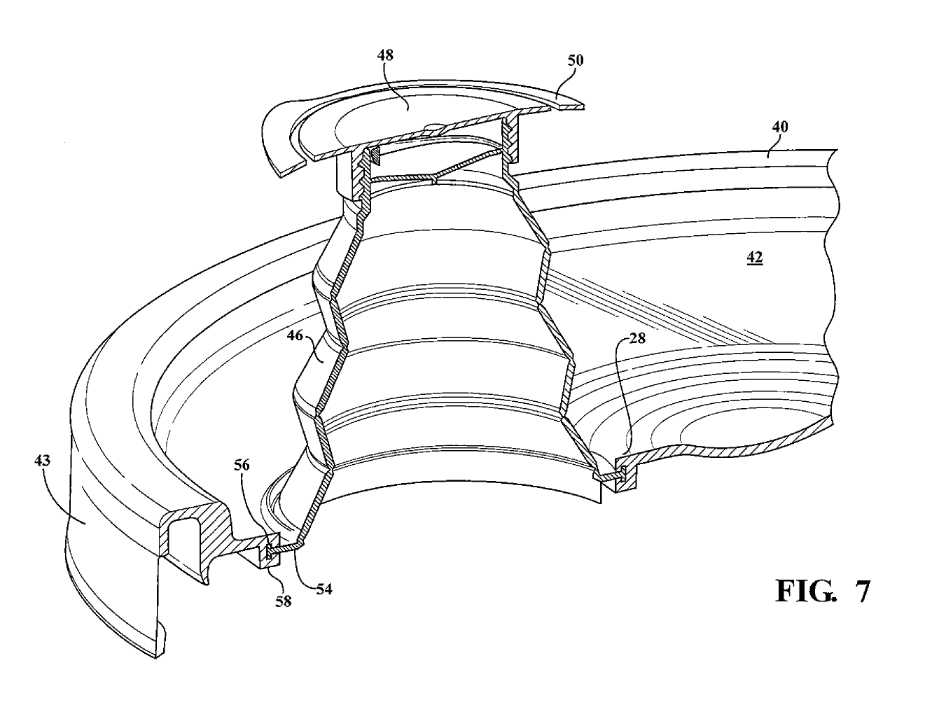

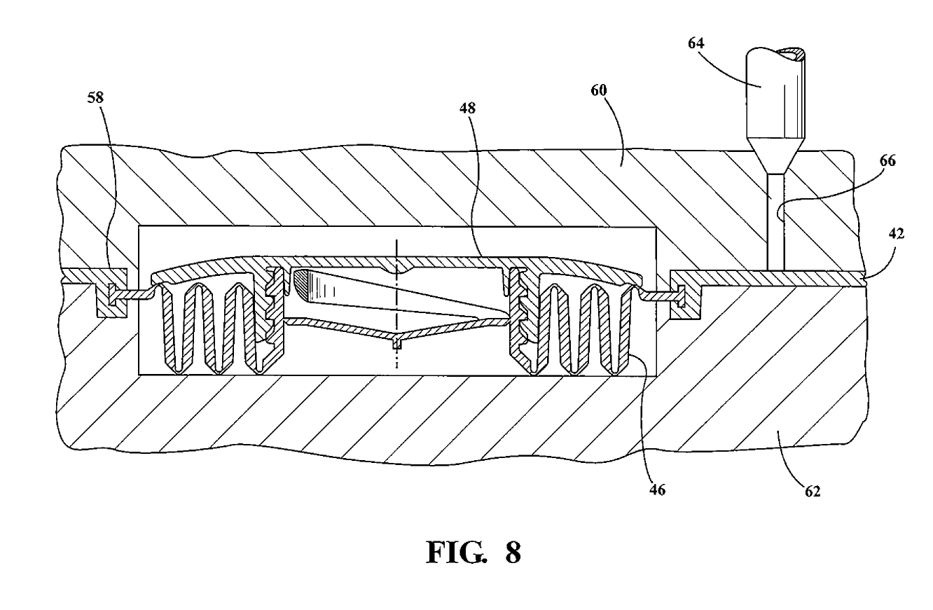

Referring to FIGS. 6 and 7, a second embodiment of the invention is shown to comprise a molded polyethylene closure 40 having a substantially planar central deck portion 42 bounded by a peripheral portion defining an inverted U-shaped channel for receiving the top flange of a container such as container 10 shown in FIG. 1. A spout assembly 44 comprising a pleated collapsible spout body 46 and a screw-on cap 48 having an integral pull-ring 50 is also illustrated. The cap is attached to the outlet end of the spout body 46 by way of threads 49 which may also take the form is one or more non-helical ridges to receive and hold the cap 48. In the embodiment of FIG. 6, the larger diameter inlet end of the spout body 46 is terminated in a flange 54 having a T-shaped annular terminal portion 56 formed integrally therewith. Again, the preferred material of construction may be high-density polyethylene but other polymeric materials can also be used.

Whereas the embodiment of FIGS. 1-5 involves attaching the separately molded spout to the downwardly extending flange 22 of the separately molded closure 16, the closure 40 in FIGS. 6 and 7 is molded to and around the flange 54 of the spout 46 in an “insert molding” process step where, as best shown in FIG. 8, the apparatus comprises upper and lower mold body portions 60, 62, a plastic injector 64 and a sprue 66 for allowing molten plastic to enter the cavity which forms the closure deck 42 and an annular portion 58 having a generally square cross-section which surrounds the T-shaped appendage 54 on the outer edge of the spout inlet. Thus, the closure 40, 42 is, therefore, molded with the spout 46 as if it were a single piece and no separate attachment step is needed. The closure 40, 42 emerges from the mold 60, 62 as a unitary pre-assembly ready to install or ship to the installation point.

Again, the pleat hinge points are thinner in cross-section than the remainder of the spout body 46 to give the hinge areas greater bending capability and to provide a memory function when returning the spout to the collapsed position shown in FIGS. 6 and 8.

What is claimed is:

1. A manually extensible plastic spout for use in combination with a container comprising:
a multiply-pleated molded plastic body forming said spout and having a first larger diameter inlet end adapted to be joined to said closure and a second, smaller diameter outlet end with a collar area adapted to receive a cap thereon; and
a cap lockingly engaged with said collar;
wherein the spout body normally occupies a collapsed condition wherein the cap is substantially flush with an exterior surface of said closure.

2. A spout as defined in claim 1 wherein the cap includes an integral pull ring which can be used to extend the spout from a collapsed condition to an extended condition.

3. A spout as defined in claim 1 further comprising a removable seal internally of said collar.

4. A spout as defined in claim 1 wherein the pleated body is molded in a collapsed condition.

5. An apparatus as defined in claim 1 further comprising a molded plastic closure having a deck with a peripherally flanged opening in said deck wherein the pleated spout body is provided at said first inlet end with an upwardly opening peripheral channel which is adapted to lockingly receive the deck flange therein.

6. A spout as defined in claim 1 wherein the pleats are annular.

7. The combination of a molded plastic closure for an open-top container wherein the closure has a deck, and an extensible plastic spout joined to said deck and extensible therefrom wherein:
said spout comprises a multiply-pleated plastic body having a larger diameter inlet end joined to said deck and a smaller diameter and a smaller diameter outlet end; and
a cap lockingly attachable to said outlet end and adapted to lie substantially flush with said deck when the spout body is in the collapsed condition.

8. The combination defined in claim 7 wherein the spout is integrally molded to the closure deck.

9. The combination defined in claim 7 wherein the spout is molded with a U-shaped peripheral channel adapted to be lockingly joined to a complemental flange formed integrally with said deck to define a spout opening.

10. In combination:
a molded plastic closure for a open-top container wherein the closure is of the type having a deck with a peripherally-flanged opening formed therein, said flange extending downwardly from the underside of the deck;
a collapsible but manually extendible spout comprising a multiply-pleated plastic body having a first larger diameter inlet end with a peripheral channel adapted to lockingly receive said flange so that the spout body mates with the closure from said underside;
said body further having a second, smaller diameter outlet end with an externally threaded collar; and
a cap threadably engaged with said collar.

11. The combination defined in claim 10 wherein the cap includes an integral pull ring which can be used to extend the spout from a collapsed condition to an extended condition.

12. The combination defined in claim 10 wherein the pleated body is molded in a collapsed condition.

13. The combination defined in claim 10 further comprising a removable seal internally of said collar.

14. The combination defined in claim 10 wherein said channel includes a detent groove.

15. A closure with pull-out pour spout comprising:
a molded plastic closure having a central deck surrounded by an integral, inverted U-shaped peripheral channel portion defining an outer skirt;
an aperture formed in said deck;
a pull-up spout having an annular larger diameter inlet end joined to said deck within said aperture and a multiply-pleated neck portion which, when collapsed, fits substantially within said aperture; and
a cap lockingly engaged with a smaller diameter outlet end of said spout and having a pull ring for lifting said spout from said collapsed condition to an expanded condition.

16. A method of manufacturing a molded plastic spout for installation in an aperture in the deck of a closure wherein the spout is characterized by a large diameter peripheral channel at one end, a small diameter threaded collar at the opposite end and multiple concentric pleats between said ends wherein the method comprises the step of:
molding the spout with the pleats and collar in a collapsed, concentric condition.

17. A method of manufacturing the combination of a molded plastic closure for an open top container and a molded plastic pour spout for discharging stored material from said container comprising the steps of:
molding a pleated spout body with the pleats in a collapsed, concentric condition; and, thereafter
molding the closure with the previously molded spout as an insert thus to join the spout body to the molded closure.
